(19) United States
(12) Patent Application Publication
(10) Pub. No.: US 2026/0089479 A1
(43) Pub. Date: Mar. 26, 2026

(54) UE MOBILITY DETECTION WITH ARTIFICIAL INTELLIGENCE (AI)

(71) Applicant: MEDIATEK INC., Hsinchu City (TW)

(72) Inventors: CHIA-SHING TAI, Hsinchu City (TW); Shao-Lun Tseng, Hsinchu City (TW); YUN-HAO WANG, Hsinchu City (TW); Jian-Nong Li, Hsinchu City (TW); CHIH-HUNG LEE, Hsinchu City (TW)

(21) Appl. No.: 18/896,389

(22) Filed: Sep. 25, 2024

(51) Int. Cl. H04W 8/02

(52) U.S. Cl. CPC H04W 8/02

(57) ABSTRACT

Apparatus and methods are provided for UE mobility prediction with AI. In one novel aspect, UE mobility prediction is performed based on UE measurement data through machine learning techniques. In one embodiment, the UE obtains a set of mobility-related data, feeds the set of mobility-related data to a mobility AI model for UE mobility prediction and obtains a UE mobility prediction based on the mobility AI model. In one embodiment, the UE mobility prediction is range-based. In another embodiment, two independent AI models are applied to predict the UE mobility under different situations, such as in-service and out-of-service. In one embodiment, the UE obtains mobility feedback from one or more UE applications and performs fine turning for the mobility AI model based on the mobility feedback.

### TECHNICAL FIELD

The disclosed embodiments relate generally to wireless communication, and, more particularly, to user equipment (UE) mobility detection with AI.

### BACKGROUND

Artificial Intelligence (AI) and Machine Learning (ML) have permeated a wide spectrum of industries, ushering in substantial productivity enhancements. In the realm of mobile communications systems, these technologies are orchestrating transformative shifts. Mobile devices are progressively supplanting conventional algorithms with AI-ML models to improve performance, user experience, and reduce complexity/overhead.

In the conventional network of the 3rd generation partnership project (3GPP) 5G new radio (NR), by leveraging AI-ML technology to address challenges due to the increased complexity of foreseen deployments. UE mobility measurement and prediction are traditionally operated based on algorithms such as doppler effect. It is hard to estimate the UE mobility in certain situations. Further, it is hard to formulate multipath inside a dense urban for the UE mobility prediction.

Improvements and enhancements are required to UE mobility prediction.

### SUMMARY

Apparatus and methods are provided for UE mobility prediction/detection with AI. In one novel aspect, UE mobility prediction is performed based on UE measurement data through machine learning techniques. In one embodiment, the UE obtains a set of mobility-related data, feeds the set of mobility-related data to a mobility AI model for UE mobility prediction and obtains a UE mobility prediction based on the mobility AI model. In one embodiment, the mobility AI model predicts the UE mobility via the modem measurement data. In one embodiment, the UE mobility prediction is range-based. In another embodiment, two independent AI models are applied to predict the UE mobility under different situations. When the UE is in service of the wireless network, a neural network-based in-service model is used. When the UE is out of service of the wireless network, a neural network-based out-of-service model is used. In one embodiment, the set of mobility-related data includes one or more UE data comprising one or more UE signal measurements from a serving cell from different RX antenna, one or more UE signal measurements from neighbor cell from different RX antenna, a UE serving cell changing times in a period, a UE full band power scan result, a frequency Received Signal Strength Indicator (RSSI) sniffer result, a time advance, and wherein the one more UE signal measurements from the serving cell or the neighboring cell comprising a Reference Signal Received Power (RSRP) measurement, a Reference Signal Received Quality (RSRQ) measurement, a Signal-to-Interference-plus-Noise Ratio (SINR) measurement, or an RSSI measurement.

In one embodiment, the UE determines the mobility AI model for the UE mobility prediction based on one or more selection factors. In one embodiment, the one or more selection factors include the UE being in service or out of service (OOS) of the wireless network. In one embodiment, the set of mobility-related data is configured based on the one or more selection factors. In one embodiment, the UE mobility prediction is a range prediction and generates a mobility label. In one embodiment, the range prediction is labelled with one of a set of mobility characteristic labels or a speed range label. In one embodiment, the set of mobility characteristic labels comprise static, walking, running, driving, traffic jam, freeway, and high speed. In yet another embodiment, the mobility label applies to the mobility AI model. In one embodiment, the UE obtains mobility feedback from one or more UE applications and performs fine turning for the mobility AI model based on the mobility feedback. In one embodiment, the fine tuning is performed on device by the UE. In one embodiment, the mobility AI model is trained on device by the UE or obtained from the wireless network.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports UE mobility prediction with AI in accordance with embodiments of the current invention.

FIG. 2 illustrates exemplary top level diagrams for the UE mobility detection with AI in accordance with embodiments of the current invention.

FIG. 3 illustrates exemplary diagrams for the different UE mobility AI models and the selection for the UE mobility prediction with AI in accordance with embodiments of the current invention.

FIG. 4 illustrates exemplary procedure diagrams for range prediction for UE mobility prediction with AI in accordance with embodiments of the current invention.

FIG. 5 illustrates an exemplary flow chart for the UE mobility prediction with AI in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Please also note that terms such as transfer means uplink transfer and/or downlink transfer.

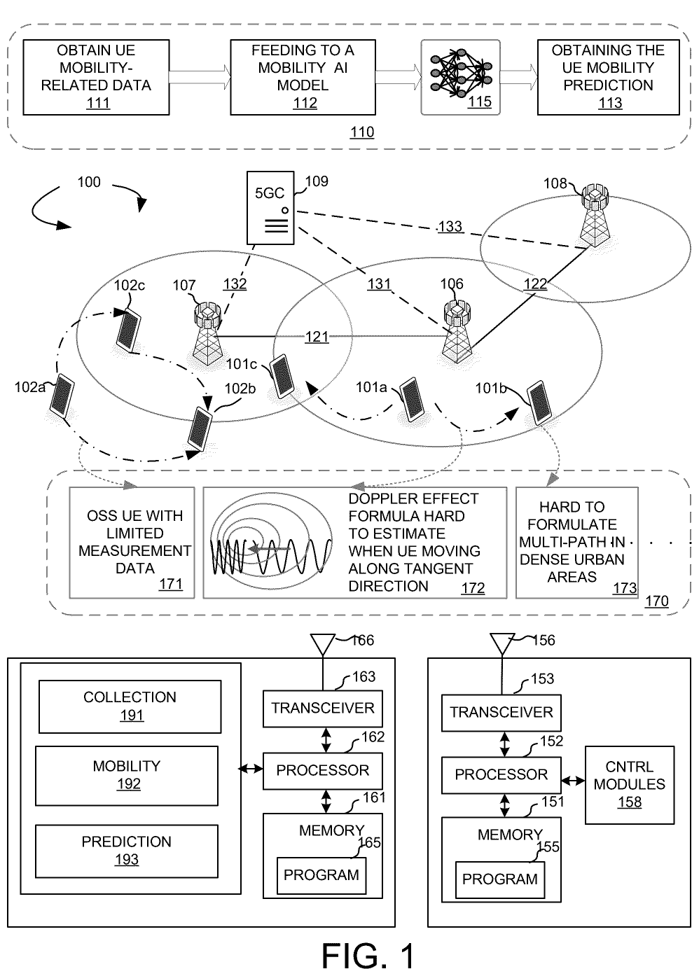

FIG. 1 is a schematic system diagram illustrating an exemplary wireless network that supports UE mobility prediction with AI in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 106, gNB 107 and gNB 108 are base stations in the wireless network, the serving area of which may or may not overlap with each other. As an example, user equipment (UE) 101 or mobile station 101 is in the serving area covered by gNB 106 and gNB 107. As an example, UE 101 or mobile station 101 is in the service area of gNB 106 and connected with gNB 106. UE 102 or mobile station 102 is out of service without connections with base station in wireless network 100. gNB 106 is connected with gNB 107 via Xn interface 121. gNB 106 is connected with gNB 108 via Xn interface 122. A 5G network entity 109 connects with gNB 106, 107, and 108 via NG connection 131, 132, and 133, respectively.

As an example, UE 101 moves from 101a to 101b. 101a and 101b are both within the service area 106. In another scenario, UE 101 moves from 101a to 101c, where UE 101 are in the service area of gNB 107. As another example, out of service (OOS) UE 102 moves from 102a to 102b, which is also out of service of the wireless network 100. In another scenario, UE 102 moves from 102a to 102c, which is in the service area of gNB 107. In a traditional way of UE mobility prediction 170, it is hard to detect the UE mobility via only modem measurement information, such as the serving cell measurement and neighbor cell measurement. multiple. In one scenario 171, OOS UEs, such as UE 102, has limited measurement data. For example, as UE 102 moves from 102a to 102b, there is more limited measurement data can be obtained for UE mobility detection. In one scenario 172, the Doppler effect formula has limitations. Although the Doppler effect formula can be used to estimate the UE mobility by the association between serving cell and the UE, the formula is hard to estimate the mobility when the UE moves along the tangent direction, such as UE 101 moves from 101a to 101b. In another scenario 173, it is hard to formulate the multi-path inside a dense urban. The machine learning technique is suitable to be utilized into the topic to predict the UE mobility with the measurement information.

In one novel aspect 110, AI-based UE mobility prediction is performed in wireless network 100. At step 111, the UE obtains UE mobility-related data. At step 112, the UE mobility-related data is fed into to a mobility AI model 115. In one embodiment, the UE selects the AI mobility model 115 based on one or more selection rules. At step 113, the UE obtains the UE mobility prediction based on AI mobility model.

FIG. 1 further illustrates simplified block diagrams of a base station and a mobile device/UE that supports UE mobility detection with AI. FIG. 1 includes simplified block diagrams of a UE, such as UE 101. The UE has an antenna 166, which transmits and receives radio signals. An RF transceiver circuit 163, coupled with the antenna, receives RF signals from antenna 166, converts them to baseband signals, and sends them to processor 162. RF transceiver 163 also converts received baseband signals from processor 162, converts them to RF signals, and sends out to antenna 166. Processor 162 processes the received baseband signals and invokes different functional modules to perform features in UE 101. Memory 161 stores program instructions and data 165 to control the operations of UE 101.

The UE also includes a set of control modules that carry out functional tasks. These control modules can be implemented by circuits, software, firmware, or a combination of them. Collection module 191 obtains a set of mobility-related data. Mobility module 192 performs a UE mobility prediction using an artificial intelligence (AI) mobility model based on the set of mobility-related data. Prediction module 193 obtains a UE mobility prediction.

FIG. 1 further illustrates simplified block diagrams of a base station, such as gNB 106. The gNB has an antenna 156, which transmits and receives radio signals. An RF transceiver circuit 153, coupled with the antenna 156, receives RF signals from antenna 156, converts them to baseband signals, and sends them to processor 152. RF transmits signal and also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 106. gNB 106 also includes a set of control modules 158 that carry out functional tasks to communicate with mobile stations. These control modules can be implemented by circuits, software, firmware, or a combination of them.

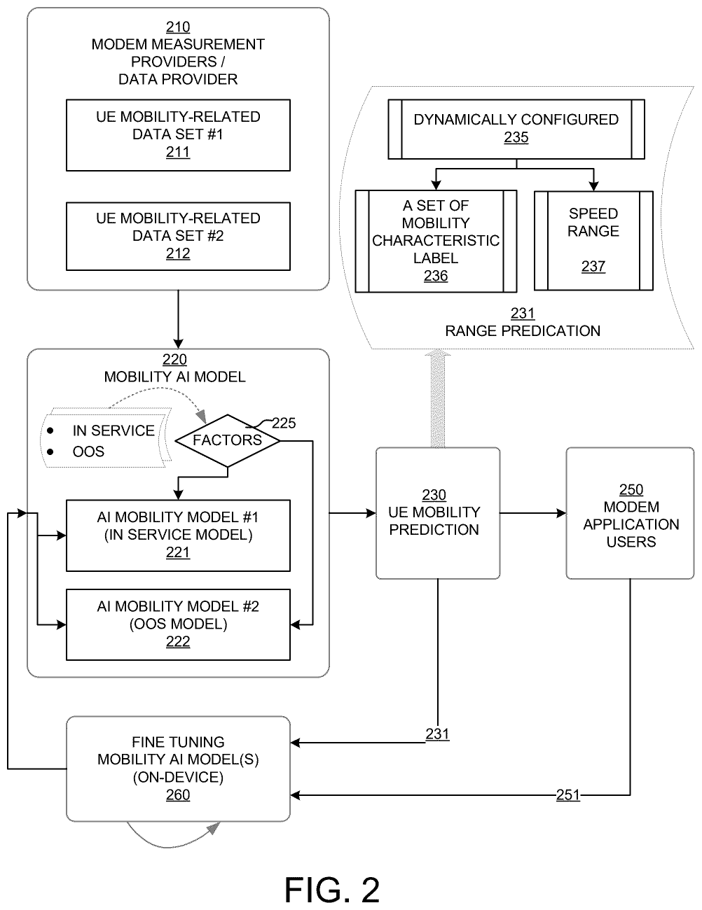

FIG. 2 illustrates exemplary top level diagrams for the UE mobility detection with AI in accordance with embodiments of the current invention. At step 210, the UE obtains a set of mobility-related data. The UE performs measurements with modem providers or other data providers. The UE collects one or more UE mobility-related data sets, such as UE mobility-related data set #1 211 and UE mobility-related data set #2 212. At step 220, the UE feeds the one or more sets of mobility-related data to a mobility AI model for UE mobility prediction. In one embodiment, the UE selects the mobility AI model for the UE mobility prediction based on one or more selection factors 225. In one embodiment, the selection factors include the UE being in-service or out-of-service. If the UE is in-service, at step 221, the UE applies in-service AI mobility model #1. If the UE is out-of-service, at step 222, the UE applies the out-of-service AI mobility model #2. At step 230, the UE obtains a UE mobility prediction based on the mobility AI model. In one embodiment 231, the mobility predication is a range prediction and outputs a velocity range label. In one embodiment 235, the range labels are dynamically configured and can be dynamically updated. In one embodiment 236, the range label is one of set of mobility characteristics. Some examples of the set of mobility characteristics includes static, walking, running, driving, traffic jam, freeway, and high speed. In another embodiment 237, the range label is a speed range, for example, the label is 10- to - 15 km/hr. In one embodiment, the range label is predefined or dynamically configured and used for the UE mobility prediction training. In another embodiment, the prediction is a velocity prediction.

In one embodiment, the UE performs UE mobility prediction feedback and fine-tuning based on the feedback. At step 250, the generated UE mobility prediction is sent to modem application users, such as mobility services of the UE. At step 251, the modem application users provide feedback for the UE mobility prediction. At step 251, the UE mobility prediction is also provided as a feedback input. At step 260, a fine-tuning for the mobility AI is based on the application user feedback and the AI UE mobility prediction output. In one embodiment, the fine-tuning is performed on the device. In one embodiment, the fine-tuning is performed for selected AI UE mobility model based on one or more selection rules. In one embodiment, when the UE is in service, the fine-tuning is performed for the in-service AI UE mobility model; and when the UE is out-of-service the fine-tuning is performed for the out-of-service AI UE mobility model.

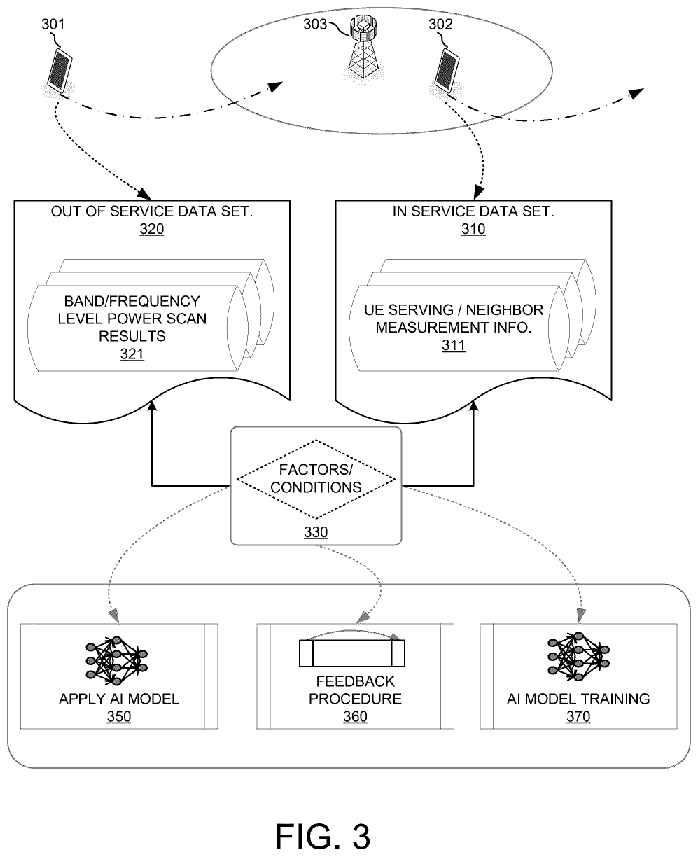

FIG. 3 illustrates exemplary diagrams for the different UE mobility AI models and the selection for the UE mobility prediction with AI in accordance with embodiments of the current invention. In one embodiment, two independent AI models are applied to predict the UE mobility under different situations. When the UE is under service scenario, a neural network (NN) based model for in service is applied. When the UE is under no service scenario, a NN based model for out-of-service is applied. gNB 303 serves a geographical area. UE 302 is in service of the wireless network. UE 301 is out of service of the wireless network. When the UE is under no service, more limited measurement data can be obtained for the UE mobility detection. In one embodiment, the UE mobility-related data includes one or more elements comprising UE signal measurements from a serving cell from different RX antenna, one or more UE signal measurements from neighbor cell from different RX antenna, a UE serving cell changing times in a period, a UE full band power scan result, a frequency Received Signal Strength Indicator (RSSI) sniffer result, a time advance, and wherein the one more UE signal measurements from the serving cell or the neighboring cell comprising a Reference Signal Received Power (RSRP) measurement, a Reference Signal Received Quality (RSRQ) measurement, a Signal-to-Interference-plus-Noise Ratio (SINR) measurement, or an RSSI measurement. In one embodiment, the out of service data set 320 includes band/frequency level scan results. The in service data set 310 includes UE serving cell and/or neighboring cell measurement information. In one embodiment, the UE determines/selects a UE mobility AI model based on one or more factors/conditions 330. In one embodiment, the one or more factors/conditions 330 is the UE being in service of the wireless network or out of service of the wireless network. In one embodiment, the factors/conditions 330 applies to different applications, including AI model application 350, feedback procedure 360, and AI model training 370. For example, when the UE is determined to be in service of the wireless network, the in-service AI model is applied to obtain the UE mobility prediction, and/or the UE collect in-service data set and feeds for the in-service AI UE mobility model training, and/or the feedback from the application users is used for fine tuning for the in-service AI UE mobility model. When the UE is determined to be out of service of the wireless network, the out-of-service AI model is applied to obtain the UE mobility prediction, and/or the UE collect out-of-service data set and feeds for the out-of-service AI UE mobility model training, and/or the feedback from the application users is used for fine tuning for the out-of-service AI UE mobility model.

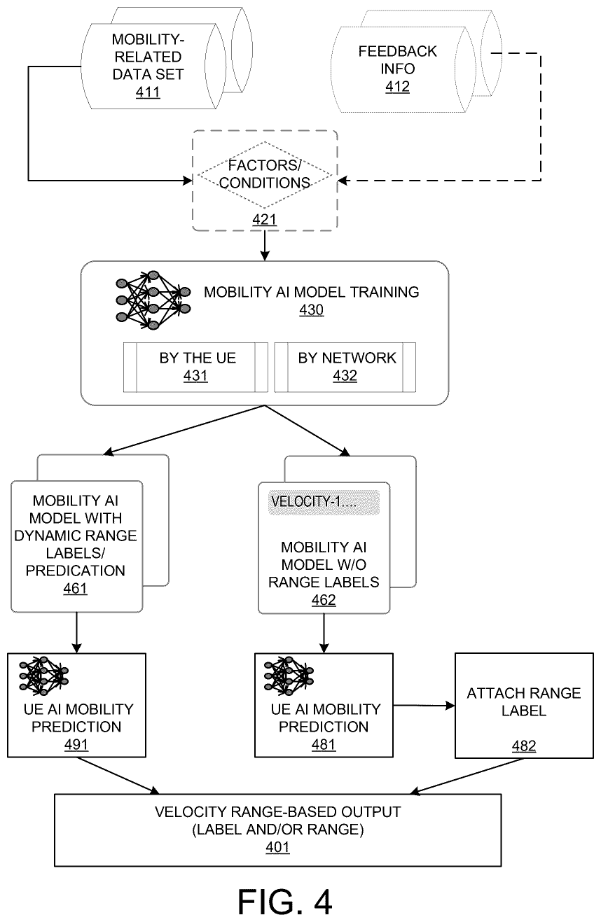

FIG. 4 illustrates exemplary procedure diagrams for range prediction for UE mobility prediction with AI in accordance with embodiments of the current invention. In one embodiment, the UE mobility prediction is a range prediction. At step 411, the UE obtains mobility-related data set. At step 412, optionally, the UE obtains feedback information for the UE mobility prediction. At step 421, the UE determines which AI UE mobility model applies based on one or more factors/conditions. In one embodiment, the factors/conditions include the UE being in service of the wireless network or out of service of the wireless network. At step 430, mobility model training is performed using the mobility-related data set and optionally feedback formation/feedback data sets. The mobility-related data set and the feedback data set are selected based on the one or more factors/conditions. For example, when the UE is in service with the wireless network, the in-service AI model training is performed with the in-service data set and optionally the in-service feedback data set. When the UE is out of service with the wireless network, the out-of-service AI model training is performed with the out-of-service data set and optionally the out-of-service feedback data set. In one embodiment 431, the mobility AI model is trained by the UE. The UE obtains the mobility-related data and optional obtains additional mobility-related data from the network. Optionally, the UE obtains the feedback data set from the application users and optionally additional feedback data from the network. The UE performs the mobility AI model training on device with the mobility-related data set and optionally feedback data set. In another embodiment 432, the mobility AI model is trained by the network. The UE collects mobility-related data set and sends the collected mobility-related data set to the network. Optionally, the UE obtains feedback data set from the UE application users and sends the feedback data set to the network. The network performs the mobility AI model training using the UE collected mobility-related data set, optionally the network side mobility-related data set and optionally feedback data set obtained from the UE, the network or both.

In one embodiment 401, velocity range-based output with mobility characteristic label or speed range label is obtained using the mobility AI model. In one embodiment 461, the mobility AI model is range-based by applying dynamic mobility characteristic labels or speed range labels, and the UE obtains range-based prediction using the mobility AI model (491). In another embodiment 462, the mobility AI model is not range-based and generates velocity predictions. At step 481, the velocity prediction is generated using the mobility AI model. At step 482, the range label is attached to the generated velocity prediction.

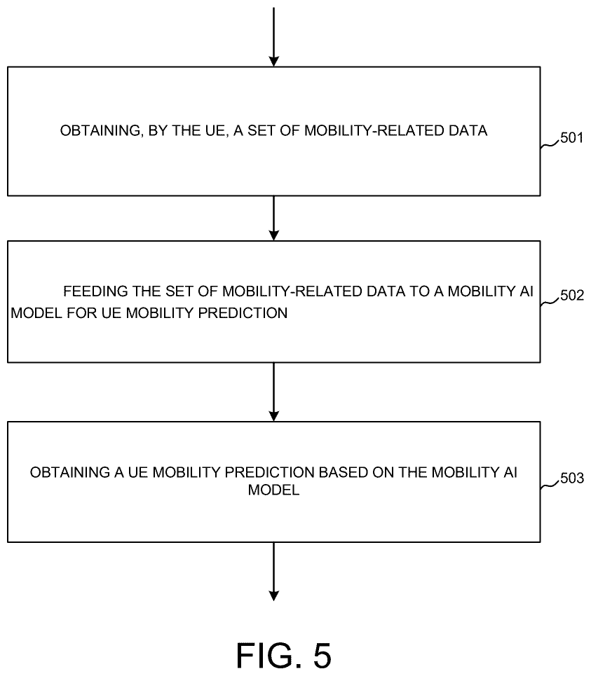

FIG. 5 illustrates an exemplary flow chart for the UE mobility prediction with AI in accordance with embodiments of the current invention. At step 501, the UE obtains a set of mobility-related data. At step 502, the UE feeds the set of mobility-related data to a mobility AI model for UE mobility prediction. At step 503, the UE obtains a UE mobility prediction based on the mobility AI model.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) using artificial intelligence (AI) model in a wireless network comprising:
obtaining, by the UE, a set of mobility-related data;
feeding the set of mobility-related data to a mobility AI model for UE mobility prediction; and
obtaining a UE mobility prediction based on the mobility AI model.

2. The method of claim 1, further comprising: determining the mobility AI model for the UE mobility prediction based on one or more selection factors.

3. The method of claim 2, wherein the one or more selection factors include the UE being in service or out of service (OOS) of the wireless network.

4. The method of claim 2, wherein the set of mobility-related data is configured based on the one or more selection factors.

5. The method of claim 1, wherein the set of mobility-related data includes one or more UE data comprising one or more UE signal measurements from a serving cell from different RX antenna, one or more UE signal measurements from neighbor cell from different RX antenna, a UE serving cell changing times in a period, a UE full band power scan result, a frequency Received Signal Strength Indicator (RSSI) sniffer result, a time advance, and wherein the one more UE signal measurements from the serving cell or the neighboring cell comprising a Reference Signal Received Power (RSRP) measurement, a Reference Signal Received Quality (RSRQ) measurement, a Signal-to-Interference-plus-Noise Ratio (SINR) measurement, or an RSSI measurement.

6. The method of claim 1, wherein the UE mobility prediction is a range prediction and generates a mobility label.

7. The method of claim 6, wherein the mobility label is one of a set of characteristic labels or a speed range.

8. The method of claim 6, wherein the mobility label applies to the mobility AI model.

9. The method of claim 1, further comprising:
obtaining mobility feedback from one or more UE applications; and
performing fine turning for the mobility AI model based on the mobility feedback.

10. The method of claim 9, wherein the fine tuning is performed on device by the UE.

11. The method of claim 1, wherein the mobility AI model is trained on device by the UE or obtained from the wireless network.

12. A user equipment (UE), comprising:
a transceiver that transmits and receives radio frequency (RF) signal in a wireless network;
a collection module that obtains a set of mobility-related data;
a mobility module that performs a UE mobility prediction using an artificial intelligence (AI) mobility model based on the set of mobility-related data; and
a prediction module that obtains a UE mobility prediction.

13. The UE of claim 12, wherein the mobility module further determines the mobility AI model for the UE mobility prediction based on one or more selection factors comprising the UE being in service or out of service (OOS) of the wireless network.

14. The UE of claim 13, wherein the set of mobility-related data is configured based on the one or more selection factors.

15. The UE of claim 12, wherein the set of mobility-related data includes one or more UE data comprising one or more UE signal measurements from a serving cell from different RX antenna, one or more UE signal measurements from neighbor cell from different RX antenna, a UE serving cell changing times in a period, a UE full band power scan result, a frequency Received Signal Strength Indicator (RSSI) sniffer result, a time advance, and wherein the one more UE signal measurements from the serving cell or the neighboring cell comprising a Reference Signal Received Power (RSRP) measurement, a Reference Signal Received Quality (RSRQ) measurement, a Signal-to-Interference-plus-Noise Ratio (SINR) measurement, or an RSSI measurement.

16. The UE of claim 12, wherein the UE mobility prediction is a range prediction and generates a mobility label.

17. The UE of claim 16, wherein the mobility label applies to the mobility AI model.

18. The UE of claim 12, further comprising:
obtaining mobility feedback from one or more UE applications; and
performing fine tuning for the mobility AI model based on the mobility feedback.

19. The UE of claim 19, wherein the fine tuning is performed on device by the UE.

20. The UE of claim 12, wherein the mobility AI model is trained on device by the UE or obtained from the wireless network.
